(19) United States
(12) Patent Application Publication
(10) Pub. No.: US 2012/0211156 A1
(43) Pub. Date: Aug. 23, 2012

(54) Multi-seasonal camouflage pattern fabrics and coatings for hunting

(76) Inventors: Benjamin Robert Harvey, Belleville (CA); William Allan Chesher, Frankford (CA)

(21) Appl. No.: 13/317,407

(22) Filed: Oct. 18, 2011

Related U.S. Application Data
(60) Provisional application No. 61/445,346, filed on Feb. 22, 2011.

(51) Int. Cl. B32B 38/14

(52) U.S. Cl. 156/277

(57) ABSTRACT

A method of making fabrics and coatings in a camouflage pattern with a printed camouflage pattern ink layer covered by a temperature activated colour changing ink layer or layers printed in a camouflage pattern, which matches the pattern in the underlying printed camouflage fabric ink layer. The temperature activated colour changing ink layer changes colour state with a change of temperature to another colour state or a clear state, which reveals the colour state of the underlying printed camouflage fabric layer. The temperatures at which the temperature activated colour changing ink changes colour state occurs at a pre-determined temperature so that the camouflage pattern reveal the colour states and the characteristics of the foliage of the season to which the temperature corresponds.

### BACKGROUND OF THE INVENTION

1. Field of the Invention

The present invention relates to camouflage pattern printed fabrics and coatings for hunting clothing and equipment which change colour with a change in temperature so that the camouflage pattern matches the season for which the temperature is typical.

2. Description of Prior Art

Printed camouflage pattern fabrics and coatings have been used in the hunting applications and environments for both clothing and equipment. The camouflage pattern is designed to conceal people, their clothing and equipment by allowing them to blend into the background environment.

Such camouflage patterns, in the hunting environment, are typically used to blend into a natural environment and are composed of leaves, trees and other vegetation with colours based on the foliage of the area in which the equipment is being used.

Printed camouflage patterns do not change colour state and the colour state of the camouflage pattern may only match one particular type of foliage at one particular time of day in one particular season. When seasons change, with the change of temperature comes a change in foliage, in terms of colour, shape and type, leaves turn brown or other colours, shrivel in the fall, fall off trees in the winter, snow may appear, while with spring the vegetation sprouts, leaves start to appear and are in full colour by the summer with the typical greens of summer.

Printed camouflage patterns do not allow for changes in the colours and characteristics of the foliage in the pattern to match the season.

Temperature activated colour changing inks are well known in a variety of arts and can be produced in various types and materials. Such inks are available which exhibit a clear or no colour state at certain temperature ranges allowing underlying colours to appear and disappear.

The present invention by creating and applying layers of temperature activated colour changing ink in a printed pattern over an underlying ink layer of printed camouflage pattern which is then applied to fabric or coatings, allows colours to appear or disappear, depending on the temperature and the season, allows foliage to change size and shape, depending on the temperature, to match the season and also can be layered in a manner which allows the colours and pattern to match the ambient daylight, depending on the time of day and the corresponding temperature during the time of day.

The present invention by its unique layering method involving multiple layers applied to the underlying fabric or equipment, creates temperature specific colours in a camouflage pattern and therefore creates season specific camouflage pattern for hunting.

### SUMMARY OF THE INVENTION

In its preferred embodiment, the invention is a printed camouflage pattern fabric or coating that allows the camouflage pattern to change colour with the change in outside temperature so that the camouflage pattern matches the colours and patterns appropriate to the season to which the temperature corresponds. The pattern matches the hunting environment allowing the hunter and the hunter's clothing and equipment to blend into the background.

In the preferred embodiment of the invention, a temperature activated colour changing ink layer or layers is applied over a printed camouflage pattern ink layer which is printed on the fabric. In the case of a printed camouflage coating, the temperature activated colour changing ink layer or layers are printed over the applied camouflage ink layer which are then applied as a coating over the equipment.

A variety of temperature activated colour changing inks may be used which contain materials capable of changes in colour state on changes in temperature and reversing the changes in colour state in response to a change of temperature back to the original temperature.

The temperature activated colour changing ink layer is printed or applied in a camouflage pattern over a printed camouflage ink layer and has a matching camouflage pattern to the underlying printed camouflage ink layer with the exception that the printed camouflage ink layer has different colour states than the temperature activated colour changing ink layer for the same portions of the camouflage pattern.

The change in temperature at the pre-determined temperature ranges causes a change in colour state from the first colour state to the second colour state in the temperature activated colour changing ink layer. This may be from a pre-determined colour state to a clear state or another colour state. With a change in the temperature, the camouflage pattern visible to the eye changes as the colour state in the underlying printed camouflage ink layer becomes visible where the temperature activated colour changing ink layer changes to a clear state allowing the previously hidden colour state of the underlying printed camouflage ink layer to become visible. The temperature activated colour changing ink layer may also change with such change in temperature to a different colour state which may include translucent colour state, which when combined or blended with the colour state of the underlying printed pattern on the printed camouflage ink layer, is a colour state different from the colour state in the temperature activated colour changing ink layer prior to the temperature change.

Additional temperature activated colour changing ink layers may be added which change colour state at different temperatures corresponding to the changes in different seasons so that the printed camouflage pattern fabric or coating can match the background foliage for multiple seasons. The colours and patterns revealed match the background colours and patterns of the foliage of the season to which the temperature corresponds.

### BRIEF DESCRIPTION OF THE DRAWINGS

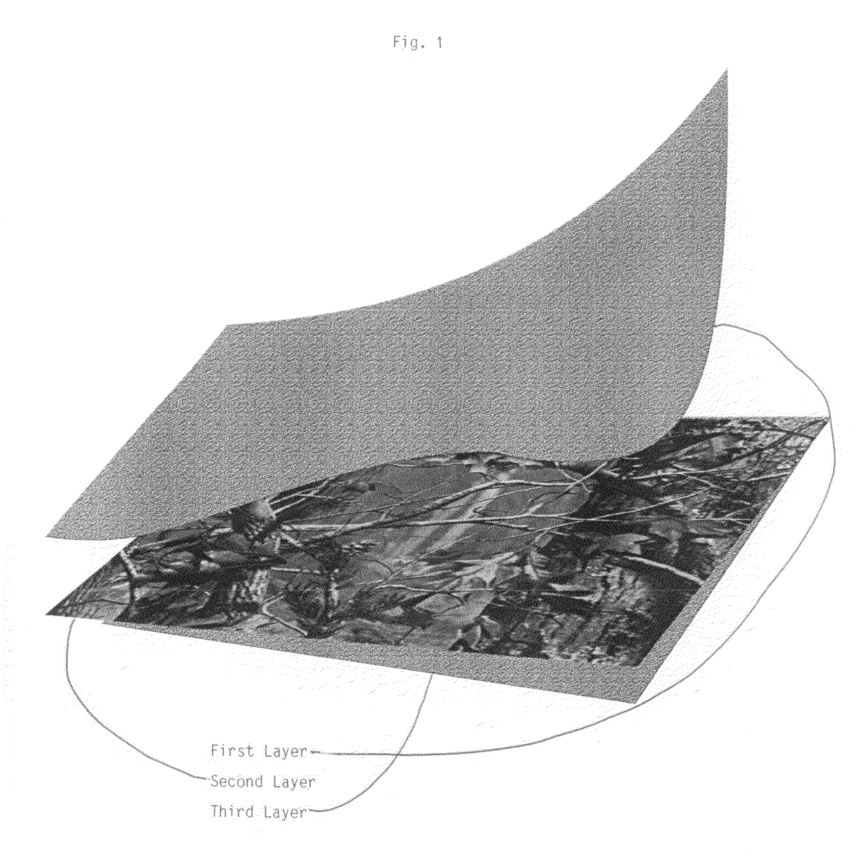

The preferred embodiment of the present invention is to be provided by way of example only with reference to the appended drawings wherein FIG. 1 is a three dimensional planar view of the printed camouflage ink layer, the temperature activated colour changing ink layer and the fabric or material to which the printed camouflage ink layer and temperature activated colour changing ink layer are attached in the preferred embodiment.

### DESCRIPTION OF THE PREFERRED EMBODIMENT

The temperature activated colour changing inks can be purchased from any one of a number of suppliers. Temperature activated colour changing inks change from one colour state to another colour state which may include a clear colourless state in response to a change in temperature. In preferred embodiment, this change is a reversible change so that when the temperature drops below a set temperature, the temperature activated colour changing ink layer changes from one colour state to another colour state and when the temperature rises above the set temperature, the temperature activated colour changing ink layer changes back to the original colour state.

Temperature sensitive colour changing inks contain materials that are temperature sensitive and change from one colour state to another colour state as a result of a change in temperature. Temperature activated colour changing ink layers can be applied to the printed camouflage ink layer which are then applied to fabric or as a coating to equipment.

It is possible to obtain temperature activated colour changing ink which changes from one colour state to another colour state or to a clear colourless state at set temperatures. Colour state change can be from one colour state to another colour state. Colour change can also be from one colour state to a clear or colourless state depending on the temperature activated colour changing ink used.

Printed camouflage ink layers applied to fabric and printed camouflage fabric for hunting can readily be obtained in the market from any one of a number of suppliers. Camouflage patterns are typically unique to the hunting equipment supplier and matches the known external environments. Camouflage patterns are typically composed of foliage such as trunks, leaves, other parts of trees or other plants with a colour pattern which matches the known environment. Such printed camouflage layers and printed camouflage fabric do not change colour with the seasons or with changes in temperature.

Printed camouflage patterns can be applied to fabric for hunting clothing and equipment to disguise the hunters from the hunters prey by blending into the foliage. Printed camouflage layers without the application of temperature sensitive colour changing ink technology are normally in a pattern and colours representing the typical background of a single season which does not change. This requires the purchase of different camouflage patterns and colours for different seasons.

In the preferred embodiment, a temperature activated colour changing ink layer is printed in the same camouflage pattern as the underlying printed camouflage ink layer but in different colour states. The temperature activated colour changing ink layer is overlaid over the printed camouflage layer to exactly match the pattern on the underlying printed camouflage ink layer although each layer will have different colours for different parts of the camouflage pattern. The inks in the underlying printed camouflage ink layer do not change colour state with temperature.

The inks or pigments in the temperature activated colour changing ink layer will change colour state at set temperatures to another colour state. This other colour state can include a colourless or clear colour state. The temperature at which the changing colour occurs is pre-determined based on the typical temperature range for the seasons in the environment in which the printed camouflage fabric and the hunting clothing from which it is made and equipment to which it is applied will be used.

By application of the different inks or pigments in different parts of the pattern in the temperature activated colour changing ink layer, only part of the pattern will change from one colour state to another colour state at the set change in temperature.

Until the change in colour state occurs, the colour of the temperature activated colour changing ink layer, except where it is in a clear colourless state, will be the visible colour for the printed camouflage pattern.

Different portions of the pattern in the temperature activated colour changing ink layer may change colour state at the pre-determined temperature to another colour state and other portions of the pattern in the temperature activated colour changing ink do not change colour state at that pre-determined temperature.

Where a portion of the temperature activated colour changing ink layer changes to a clear colourless state, the colour on the underlying printed camouflage ink layer in respect of that portion of the underlying printed camouflage ink layer and the printed camouflage pattern is revealed.

Where the temperature activated colour changing ink layer changes from one colour state to another colour state which is different from the original colour state and also different from the colour state on the corresponding pattern of the underlying printed camouflage layer and such new colour state is not opaque, but is translucent, then the blending of the two colour states will occur creating a new visible colour state different from both layers.

The temperature activated colour changing ink layer may be comprised of different colours for each portion of the camouflage pattern. Each portion of the camouflage pattern in the temperature activated colour changing ink layer may change to a different colour state than other portions of the temperature activated colour changing ink layer.

The colour states of two portions of the temperature activated colour changing ink layer may be the same, but the colour state on the underlying printed camouflage pattern for each of the portions may be different, resulting in different colours for different portions of the printed camouflage fabric at different temperature ranges and different seasons.

Changes in colour state in the temperature activated colour changing ink layer can occur at different temperatures using different pigments or inks for different portions of the pattern.

The colour states which are visible in the printed camouflage fabric or coating may be contained in the temperature activated colour changing ink layer or the underlying printed camouflage layer or a combination of both the temperature activated ink layer and the underlying printed camouflage layer. The colour states will match the colours for the foliage typical of the season for which the type of camouflage pattern is used.

For example, if the temperature is above the temperature which is a typical summer temperature, the printed camouflage fabric can show primarily summer colour states such as greens representing summer season foliage and vegetation.

When the temperature range drops to a temperature which would be typical for a fall temperature in the area in which the printed camouflage fabric or coating is being used, then a change in colour state occurs in the temperature activated colour changing ink layer and the colours in the resulting printed camouflage fabric will match the typical fall colour states for the foliage in the area.

Another feature of the layering effect of a temperature activated colour changing ink layer overlying the printed camouflage ink layer is that when the temperature activated colour changing ink layer goes clear, it can show different underlying shapes of the foliage with printed camouflage ink layer, which shapes of the foliage match the shapes of the foliage for the season at which the temperature change occurs. The pattern on the underlying printed camouflage ink layer may be different from the pattern on the temperature activated colour changing ink layer.

For example, if the temperature activated colour changing ink layer is above the typical summer temperature for the area in which the printed camouflage fabric or coating is used, then the pattern in the temperature activated colour changing ink layer would be of full leaves on trees and other plants and foliage showing summer colours for such leaves and foliage such as greens. When the temperature changes below the typical summer temperature to a temperature which would be more typical of a fall season temperature in the area in which the printed camouflage fabric or coating is used, then the leaf portion of the camouflage pattern on the temperature activated colour changing ink layer would then change to a clear colourless state and the underlying pattern, which would not be a full leaf, but a shriveled leaf or a leaf of a reduced size or shape to match the season and with a different colour state to match the season, such as a brown, is revealed.

Another feature of the layering effect is that multiple layers of temperature activated colour changing inks can be used with different changes based on different set temperatures. For example, the first temperature activated colour changing ink layer could have a pattern and colours representing the winter season. This temperature activated colour changing ink layer would then change to a clear colourless state at a pre-determined temperature which matches the change of temperature on the change in season from winter to spring revealing on the second, underlying layer of temperature activated colour changing ink with a pattern and colours representing the spring season. The second temperature activated colour changing ink layer could change colour state to a clear or colourless state at a predeterminated temperature which corresponds with the change in season from the spring season to the summer season revealing the underlying printed camouflage colours and patterns of the printed camouflage ink layer corresponding to the summer season with summer colours and foliage. This could be used in other combinations including a winter, fall, summer combination of temperature activated colour changing ink layers.

The layers could also be used to change colours and patterns in the camouflage pattern to correspond to temperatures to match hunting hour changes from daylight to evening so that at temperature ranges typical of daylight during the hunting season, the camouflage pattern and colours typical for daylight would show on the camouflage pattern of the temperature activated colour changing ink layer and on a drop in temperature corresponding to temperature for evening hours, the temperature activated colour changing ink layer would change to a clear colourless state showing the underlying camouflage pattern ink layer and colours which would be typical for evening hours with shadows and darker colours typical of lower light conditions.

We claim:

1. A method for producing printed camouflage patterns on fabric for hunting clothing which changes the colours of the printed camouflage pattern to match the ambient temperatures of the season, comprising the steps of:
a) forming a first printed camouflage pattern in a layer of printed ink which does not change colour state with a change in temperature;
b) forming a second printed camouflage pattern ink layer comprised of a temperature activated colour changing ink in an identical camouflage pattern other than colour state to the camouflage pattern of the first printed camouflage ink layer which the temperature activated colour changing ink layer changes colour state when the temperature falls below a preset temperature to a different colour state;
c) applying the second temperature activated colour change ink layer over the underlying first printed camouflage ink layer;
d) applying the combined first printed camouflage pattern ink layer and the second temperature activated colour changing ink layer to a fabric layer.

2. The method of claim 1 where the first printed camouflage ink layer and the second temperature activated colour changing ink layer are applied as a coating to equipment.

3. The method of claim 1 where the first colour state of the second temperature activated colour changing ink layer is a clear colourless state and the second colour state of the second temperature activated colour changing ink layer is coloured.

4. The method of claim 1, where the first colour state of the second temperature activated colour changing ink layer is coloured and the second colour state of the second temperature activated colour changing ink layer is a clear colourless state.

5. The method of claim 1 wherein only portions of the camouflage pattern in the second temperature activated colour changing ink layer are capable of changes in colour state with a change below a preset temperature.

6. The method in claim 1 wherein the second temperature activated colour changing ink layer has different colour state changes at different temperatures for different portions of the camouflage pattern.

7. The method of claim 1 where portions of the camouflage pattern in the first underlying printed camouflage ink layer are not identical to, but are different than the portions of the printed camouflage pattern in the second temperature activated colour changing ink layer lying directly over top of such portions of the first underlying printed camouflage ink layer.

8. We claim a method for producing printed camouflage patterns on fabric and coatings for hunting clothing and equipment which changes the colours of the printed camouflage pattern to match the ambient temperatures of the season, comprising the steps of:
a) forming a first printed camouflage pattern in a layer of printed ink which does not change colour state with a change in temperature;
b) forming a second printed camouflage pattern ink layer comprised of a temperature activated colour changing ink in an identical camouflage pattern other than colour states to the camouflage pattern of the first printed camouflage ink layer which the temperature activated colour changing ink layer changes colour state when the temperature falls below a preset temperature to a different colour state;
c) applying the second temperature activated colour change ink layer over the underlying first printed camouflage ink layer;
d) forming a third temperature activated colour changing ink layer overlying the second temperature activated colour changing ink layer, having the same camouflage pattern other than colour state as the second temperature activated colour changing ink layer, but which changes from one colour state to another colour state at a different preset temperature than the second temperature activated colour changing ink layer;
e) applying the third temperature activated colour changing ink layer, the second temperature activated colour changing ink layer and the first underlying printed camouflage pattern ink layer to the fabric.

9. The method of claim 8 where the first colour state of the third temperature activated colour changing ink layer is a clear colourless state and the second colour state of the third temperature activated colour changing ink layer is coloured state.

10. The method of claim 8 where the first colour state of the third temperature activated colour changing ink layer is a coloured state and the second colour state of the third temperature activated colour changing ink layer is a clear colourless state.

11. The method of claim 8 where portions of the camouflage patterns in the first underlying printed camouflage ink layer, the second temperature activated colour changing ink layer and the third colour changing ink layer are different from the portions of the camouflage pattern in such layers lying directly over top of such portions of the other layers.
